(19) United States
(12) Patent Application Publication
(10) Pub. No.: US 2019/0346748 A1
(43) Pub. Date: Nov. 14, 2019

(54) ACTUATOR AND CAMERA DRIVER

(71) Applicant: Panasonic Intellectual Property Management Co., Ltd., Osaka (JP)

(72) Inventors: Yasuaki KAMEYAMA, Osaka (JP); Teruyuki TAKIZAWA, Osaka (JP); Hironori TOMITA, Nara (JP); Masakazu KOBAYASHI, Osaka (JP); Hirohide ICHIHASHI, Osaka (JP); Tsubasa HOSHINO, Osaka (JP); Hisashi HIRAKI, Osaka (JP); Tomonari KURIAKI, Osaka (JP); Zennosuke YAMASHITA, Osaka (JP)

(21) Appl. No.: 16/522,285

(22) Filed: Jul. 25, 2019

Related U.S. Application Data
(63) Continuation of application No. PCT/JP2018/000338, filed on Jan. 10, 2018.

(30) Foreign Application Priority Data
Jan. 27, 2017 (JP) 2017-013365

(51) Int. Cl. G03B 17/56; G03B 5/00

(52) U.S. Cl. CPC G03B 17/561; G03B 2205/0069; G03B 5/00

(57) ABSTRACT

An actuator includes: a movable unit to hold a camera device thereon; a fixed unit; and at least two bundles of cables. Each of the at least two bundles of cables has an anisotropic flexural property. Each bundle of cables has an extension point. The bundle of cables is extended from the movable unit at the extension point so as to distance itself from a center of rotation. When measured along an optical axis of the camera device, distance from the center of rotation of the movable unit to the extension point is shorter than distance from the center of rotation to a first connector.

### CROSS-REFERENCE TO RELATED APPLICATIONS

This application is a U.S. continuation of International Patent Application No. PCT/JP2018/000338, filed on Jan. 10, 2018, which in turn claims the benefit of priority to Japanese Patent Application No. 2017-013365, filed on Jan. 27, 2017, the entire disclosures of which are hereby incorporated by reference.

### TECHNICAL FIELD

The present disclosure generally relates to an actuator and a camera driver, and more particularly relates to an actuator and camera driver configured to drive an object to be driven in rotation.

### BACKGROUND ART

A camera driver with the ability to rotate a camera unit along three axes been known in the art (see, for example, JP 5802192 B2). The camera driver of JP 5802192 B2 outputs a video signal, captured by the camera unit, to an external circuit via a flexible printed circuit board (flexible flat cable). This allows the camera driver of JP 5802192 B2 to rotate the camera unit along the three axes and output an image captured to the external circuit.

In general, the flexible printed circuit board has an anisotropic flexural property that makes itself easily foldable along the width thereof but makes itself difficult to fold perpendicular to its width. Therefore, depending on a positional relationship between the center of rotation and the flexible printed circuit board, as the movable unit thereof rotates, the flexible printed circuit board could be bent in such a direction in which the flexible printed circuit board is not easily foldable. In that case, significant force will be required to rotate the movable unit that holds the object to be driven (i.e., the camera unit) thereon, thus making it difficult to smoothly rotate the object to be driven.

### SUMMARY

The present disclosure provides an actuator and camera driver with the ability to smoothly rotate the movable unit even when a bundle of cables with such an anisotropic flexural property is used.

An actuator according to an aspect of the present disclosure includes a movable unit, a fixed unit, and at least two bundles of cables. The movable unit holds an optical system device thereon. The fixed unit supports the movable unit so as to make the movable unit rotatable. The at least two bundles of cables each have an anisotropic flexural property. Each of the at least two bundles of cables includes a flexible portion between a first end thereof electrically connected to the optical system device and a second end thereof electrically connected to an external circuit. Respective flexible portions of the at least two bundles of cables are arranged at equal intervals along a circumference of a circle drawn around a center of rotation of the movable unit in a neutral position. Each of the at least two bundles of cables has an extension point. The bundle of cables is extended from the movable unit at the extension point so as to distance itself from the center of rotation. When measured along an optical axis of the optical system device, distance from the center of rotation to the extension point is shorter than distance from the center of rotation to a connection terminal at the first end.

A camera driver according to another aspect of the present disclosure includes the actuator described above, and a camera device serving as the optical system device.

### BRIEF DESCRIPTION OF DRAWINGS

FIG. 1A is a plan view of a camera driver including an actuator according to an embodiment of the present disclosure;

FIG. 1B is a cross-sectional view taken along the plane X1-X1 of the camera driver;

FIG. 2 is a perspective view of the camera driver;

FIG. 3 is an exploded perspective view of the camera driver;

FIG. 4 is an exploded perspective view of a movable unit included in the actuator;

FIG. 5 is a cross-sectional view taken along the plane X2-X2 of the camera driver;

FIG. 6 is a cross-sectional view taken along the plane X3-X3 of the camera driver;

FIG. 7 is a cross-sectional view taken along the plane Y-Y of the camera driver; and

FIG. 8 is a cross-sectional view illustrating a camera driver according to a variation.

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure.

### Embodiments

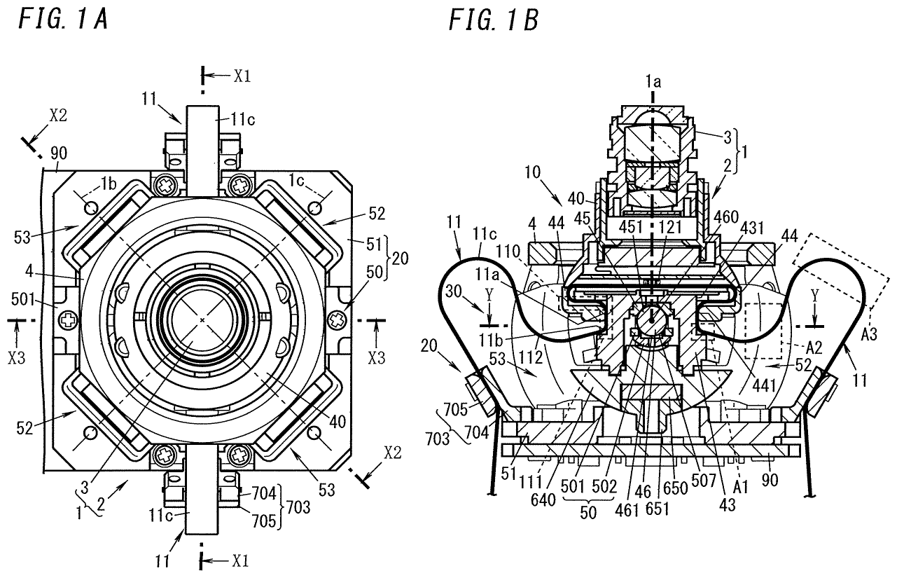

A camera driver 1 according to this embodiment will be described with reference to FIGS. 1A-7.

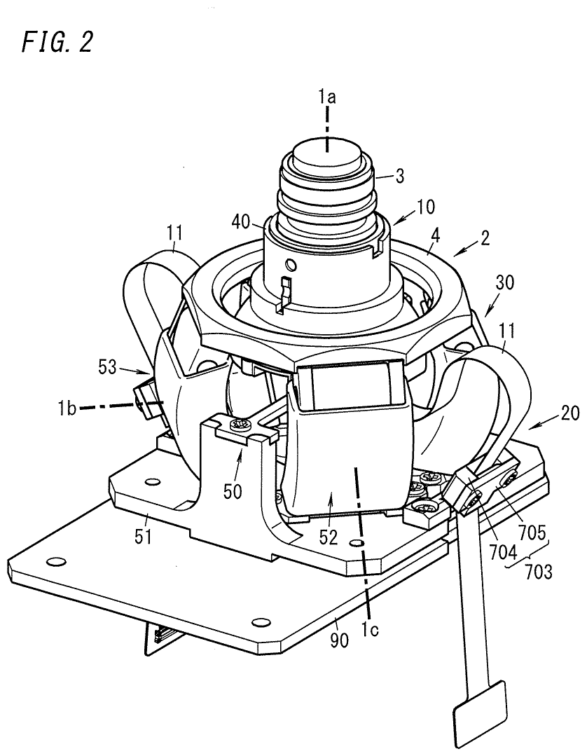

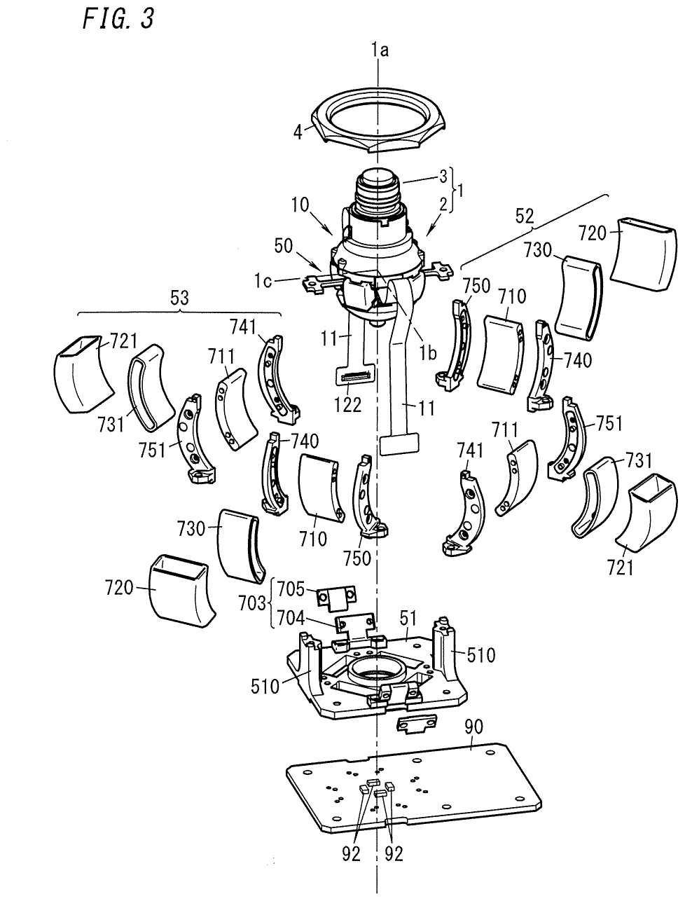

The camera driver 1 may be a portable camera, for example, and includes an actuator 2 and a camera device 3 as shown in FIGS. 2 and 3.

The camera device 3 includes an image sensor, a lens for foaming a subject image on the image capturing plane of the image sensor, and a lens barrel for holding the lens. The camera device 3 converts video produced on the image capturing plane of the image sensor into an electrical signal. Also, a plurality of cables to transmit the electrical signal generated by the image sensor to an external image processor circuit (as an exemplary external circuit) are electrically connected to the camera device 3 via a connector. The camera device 3 transmits, by the low voltage differential signaling (LVDS) method, the electrical signal thus generated to the external image processor circuit via the plurality of cables. Note that in this embodiment, the plurality of cables includes coplanar waveguides or micro-strip lines. Alternatively, the plurality of cables may each include fine-line coaxial cables each having the same length. Note that the LVDS method is only an example and should not be construed as limiting. Those cables are grouped into two bundles of cables 11 with an anisotropic flexural property so that each bundle of cables 11 consists of the same number of cables. The bundles of cables 11 may be implemented as flexible flat cables, for example. The flexural property is represented by a relationship between the stress produced under a bending load (bending stress) and the magnitude of displacement (or the flexible volume). In the case of flexible flat cables, the flexural property thereof perpendicular to the flat surface of the bundle of cables 11 is different from the flexural property thereof measured along the flat surface thereof and perpendicular to the direction in which the bundle of cables 11 extends. A first end that is a terminal of the bundle of cables 11 is connected to a first connector 121 of a rigid portion 12 to be electrically connected to the camera device 3. In this case, the first connector 121 serves as a connection terminal at the first end. A second end that is the other terminal of the bundle of cables 11 is connected to a second connector 122 to be electrically connected to the image processor.

The actuator 2 includes an upper ring 4, a movable unit 10, a fixed unit 20, a driving unit 30, and a printed circuit board 90 as shown in FIG. 2.

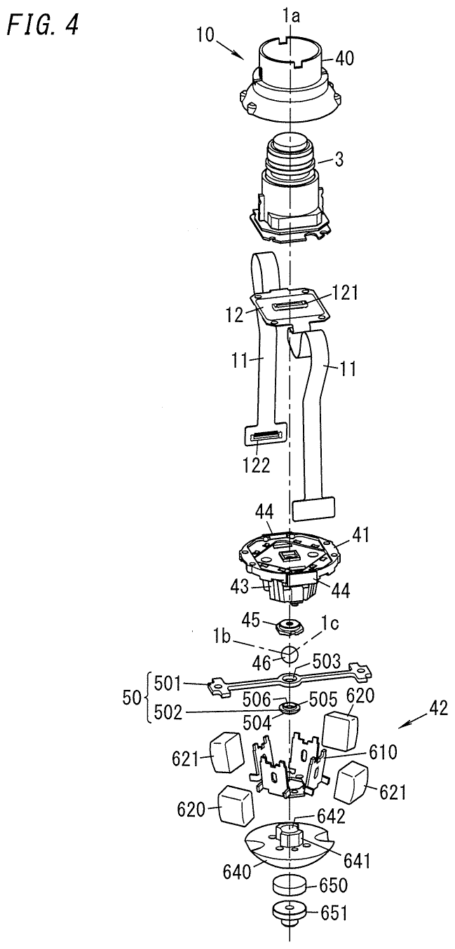

The movable unit 10 includes a camera holder 40, a first movable base 41, and a second movable base 42 (see FIG. 4): The movable unit 10 is fitted into the fixed unit 20 with some gap left between the movable unit 10 and the fixed unit 20. The movable unit 10 rotates (i.e., rolls) around the optical axis la of the lens of the camera device 3 with respect to the fixed unit 20. The movable unit 10 also rotates around an axis 1b and an axis 1c, which are both perpendicular to the optical axis 1a, with respect to the fixed unit 20. In this case, the axis 1b and the axis 1c are both perpendicular to a fitting direction, in which the movable unit 10 is fitted into the fixed unit 20 while the movable unit 10 is not rotating. Furthermore, these axes 1b and 1c intersect with each other at right angles. A detailed configuration for the movable unit 10 will be described later. The camera device 3 has been mounted on the camera holder 40. The configuration of the first movable base 41 and the second movable base 42 will be described later. Rotating the movable unit 10 allows the camera device 3 to rotate. In this embodiment, when the optical axis 1a is perpendicular to both of the axes 1b and 1c, the movable unit 10 (i.e., the camera device 3) is defined to be in a neutral position. In the following description, the direction in which the movable unit 10 (camera device 3) rotates around the axis 1b is defined herein as a “panning direction” and the direction in which the movable unit 10 (camera device 3) rotates around the axis 1c is defined herein as a “tilting direction.” Furthermore, the direction in which the movable unit 10 (camera device 3) rotates (rolls) around the optical axis 1a is defined herein as a “rolling direction.” Note that all of the optical axis 1a and the axes 1b and 1c are virtual axes.

The fixed unit 20 includes a coupling member 50 and a body 51 (see FIG. 3).

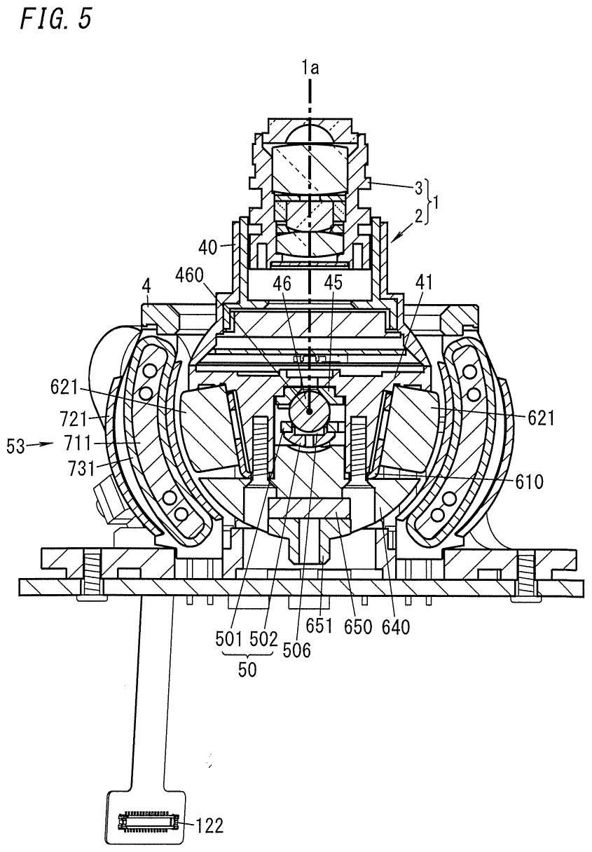

The coupling member 50 includes a linear coupling bar 501 and a loosely fitting member 502. The coupling bar 501 has an opening 503 cut through a middle portion thereof. The loosely fitting member 502 includes a base 504 and a wall 505. When viewed along the optical axis 1a of the camera device 3 in the neutral position, the base 504 has a circular shape. One surface, closer to the camera device 3, of the base 504 is a flat surface, while the other surface, more distant from the camera device 3, of the base 504 is a spherical surface. The wall 505 is provided around the center of the flat surface of the base 504 and has a recess 506 (see FIGS. 4 and 5). The diameter of the outer periphery of the wall 505 is approximately equal to the diameter of the opening 503 of the coupling bar 501. The wall 505 is fitted into the opening 503 of the coupling bar 501.

The body 51 includes a pair of protrusions 510. The pair of protrusions 510 are provided so as to face each other in a direction perpendicular to the optical axis la of the movable unit 10 in the neutral position. The pair of protrusions 510 are also provided to be located in the gaps between the first coil units 52 and second coil units 52 arranged (to be described later). The coupling member 50 is screwed onto the body 51 with the second movable base 42 interposed between itself and the body 51. Specifically, both ends of the coupling member 50 are respectively screwed onto the pair of protrusions 510 of the body 51.

The body 51 is provided with two fixing portions 703 for fixing the two bundles of cables 11 thereto (see FIGS. 1B-3). The two fixing portions 703 are arranged to face each other perpendicularly to the direction in which the pair of protrusions 510 are arranged. The two fixing portions 703 are provided for the body 51 so as to tilt toward the camera device 3 with respect to a plane including the axes 1b and 1c (see FIG. 3). Each of the two fixing portions 703 includes a first member 704 and a second member 705, both of which are formed in a plate shape. An associated bundle of cables 11 is partially clamped between the first and second members 704 and 705.

The fixed unit 20 includes a pair of first coil units 52 and a pair of second coil units 53 to make the movable unit 10 electromagnetically drivable and rotatable (see FIG. 3). The pair of first coil units 52 allows the movable unit 10 to rotate around the axis 1b. The pair of second coil units 53 allows the movable unit 10 to rotate around the axis 1c.

The pair of first coil units 52 each include a first magnetic yoke 710 made of a magnetic material, drive coils 720 and 730, and magnetic yoke holders 740 and 750 (see FIG. 3). Each of the first magnetic yokes 710 has the shape of an arc, of which the center is defined by the center of rotation 460. The drive coils 730 are each formed by winding a conductive wire around its associated first magnetic yoke 710 such that its winding direction is defined around the axis 1b (i.e., the direction in which the second coil units 53 face each other) and that the pair of first drive magnets 620 (to be described later) are driven in rotation in the rolling direction. As used herein, the winding direction of the coil refers in this embodiment to a direction in which the number of turns increases (e.g., an axial direction in the case of a cylindrical coil). After each drive coil 730 has been formed around its associated first magnetic yoke 710, the magnetic yoke holders 740 and 750 are secured with screws onto the first magnetic yoke 710 on both sides thereof. Thereafter, the drive coils 720 are each fowled by winding a conductive wire around its associated first magnetic yoke 710 such that its winding direction is defined around the optical axis la when the movable unit 10 is in the neutral position and that the pair of first drive magnets 620 are driven in rotation in the panning direction. Then, the pair of first coil units 52 are secured with screws onto the body 51 so as to face each other when viewed from the camera device 3 (see FIG. 1A). Specifically, each of the first coil units 52 has one end thereof along the optical axis 1a secured with a screw onto the body 51. Each of the first coil units 52 has the other end thereof along the optical axis 1a fitted into the upper ring 4.

The pair of second coil units 53 each include a second magnetic yoke 711 made of a magnetic material, drive coils 721 and 731, and magnetic yoke holders 741 and 751 (see FIG. 3). Each of the second magnetic yokes 711 has the shape of an arc, of which the center is defined by the center of rotation 460 (see FIG. 5). The drive coils 731 are each formed by winding a conductive wire around its associated second magnetic yoke 711 such that its winding direction is defined around the axis 1c (i.e., the direction in which the first coil units 52 face each other) and that the pair of second drive magnets 621 (to be described later) are driven in rotation in the rolling direction. After each drive coil 731 has been formed around its associated second magnetic yoke 711, the magnetic yoke holders 741 and 751 are secured with screws onto the second magnetic yoke 711 on both sides thereof Thereafter, the drive coils 721 are each formed by winding a conductive wire around its associated second magnetic yoke 711 such that its winding direction is defined around the optical axis la when the movable unit 10 is in the neutral position and that the pair of second drive magnets 621 are driven in rotation in the tilting direction. Then, the pair of second coil units 53 are secured with screws onto the body 51 so as to face each other when viewed from the camera device 3 (see FIG. 1A). Specifically, each of the second coil units 53 has one end thereof along the optical axis la secured with a screw onto the body 51. Each of the second coil units 53 has the other end thereof along the optical axis la fitted into the upper ring 4.

The camera holder 40 on which the camera device 3 has been mounted is secured with screws onto the first movable base 41. The coupling member 50 is interposed between the first movable base 41 and the second movable base 42.

The printed circuit board 90 includes a plurality of (e.g., four in this embodiment) magnetic sensors 92 for detecting rotational positions in the panning and tilting directions of the camera device 3. In this embodiment, the magnetic sensors 92 may be implemented as Hall elements, for example. On the printed circuit board 90, further assembled are a circuit for controlling the amount of a current allowed to flow through the drive coils 720, 721, 730, and 731 and other circuits.

Next, detailed configurations for the first movable base 41 and the second movable base 42 will be described.

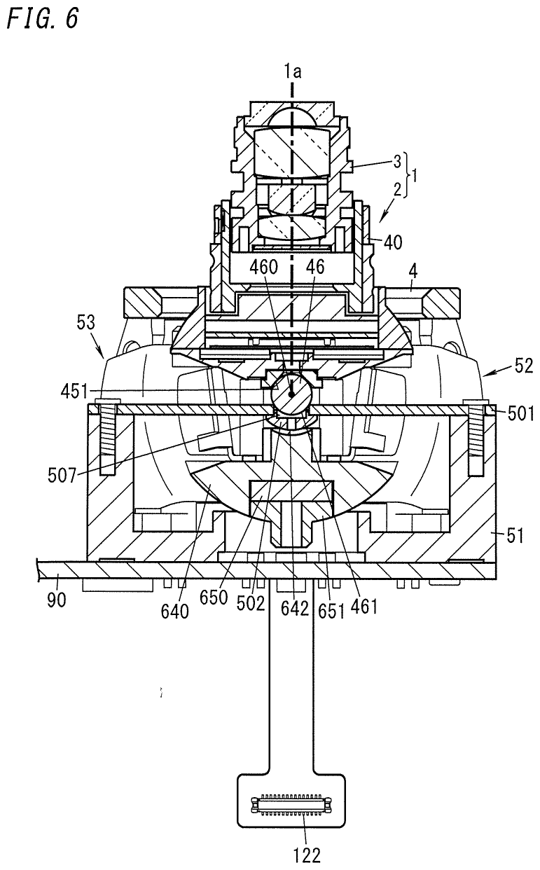

The first movable base 41 includes a body 43, a pair of holding portions 44, a loosely fitting member 45, and a spherical body 46 (see FIG. 4). The body 43 sandwiches the rigid portion 12 between itself and the camera holder 40 to fix (hold) the rigid portion 12 thereon. The respective holding portions 44 are provided for the peripheral edge of the body 43 so as to face each other (see FIG. 4). Each holding portion 44 clamps and holds an associated bundle of cables 11 between itself and a sidewall 431 of the body 43 (see FIG. 1B). The loosely fitting member 45 has a tapered through hole 451 (see FIG. 6). The spherical body 46 is fitted and fixed into the through hole 451 of the loosely fitting member 45 and has a first loosely fitting face 461 as a raised spherical surface (see FIG. 6). The first loosely fitting face 461 makes a point or line contact with a second loosely fitting face 507 of the wall 505 of the loosely fitting member 502 so as to be loosely fitted into the second loosely fitting face 507 with a narrow gap left between them. This allows the coupling member 50 to pivotally support the movable unit 10 to make the movable unit 10 rotatable. In this case, the center of mass of the spherical body 46 defines the center of rotation 460.

The second movable base 42 supports the first movable base 41. The second movable base 42 includes a back yoke 610, a pair of first drive magnets 620, and a pair of second drive magnets 621 (see FIG. 4). The second movable base 42 further includes a bottom plate 640, a position detecting magnet 650, and a stopper member 651 (see FIG. 4).

The back yoke 610 includes a disk portion and four fixing portions (arms) extending from the outer periphery of the disk portion toward the camera device 3 (i.e., upward). Two out of the four fixing portions face each other along the axis 1b, while the other two fixing portions face each other along the axis 1c. These four fixing portions correspond one to one to the pair of first coil units 52 and the pair of second coil units 53.

The pair of first drive magnets 620 are provided one to one for two fixing portions, facing the pair of first coil units 52, out of the four fixing portions of the back yoke 610. The pair of second drive magnets 621 are provided one to one for two fixing portions, facing the pair of second coil units 53, out of the four fixing portions of the back yoke 610.

Electromagnetic driving by the first drive magnets 620 and the first coil units 52 and electromagnetic driving by the second drive magnets 621 and the second coil units 53 allow the movable unit 10 (camera device 3) to rotate in the panning, tilting, and rolling directions. Specifically, electromagnetic driving by the two drive coils 720 and the two first drive magnets 620 and electromagnetic driving by the two drive coils 721 and the two second drive magnets 621 allow the movable unit 10 to rotate in the panning and tilting directions. Meanwhile, electromagnetic driving by the two drive coils 730 and the two first drive magnets 620 and electromagnetic driving by the two drive coils 731 and the two second drive magnets 621 allow the movable unit 10 to rotate in the rolling direction.

The bottom plate 640 is a non-magnetic member and may be made of brass, for example. The bottom plate 640 is attached to the back yoke 610 to define the bottom of the movable unit 10 (i.e., the bottom of the second movable base 42). The bottom plate 640 is secured with screws onto the back yoke and the first movable base 41. The bottom plate 640 serves as a counterweight. Having the bottom plate 640 serve as a counterweight allows the center of rotation 460 to agree with the center of gravity of the movable unit 10. That is why when external force is applied to the entire movable unit 10, the moment of rotation of the movable unit 10 around the axis 1b and the moment of rotation of the movable unit 10 around the axis 1c both decrease. This allows the movable unit 10 (or the camera device 3) to be held in the neutral position, or to rotate around the axes 1b and 1c, with less driving force.

One surface, located closer to the camera device 3, of the bottom plate 640 is a flat surface, a central portion of which has a projection 641. The projection 641 has a curved recess 642 at the tip. The loosely fitting member 502 is located closer to the camera device 3 than (i.e., arranged over) the recess 642.

The other surface, located more distant from the camera device 3, of the bottom plate 640 is a spherical surface, a central portion of which has a recess. In the recess, arranged are the position detecting magnet 650 and the stopper member 651 (see FIGS. 1B, 5, and 6). The stopper member 651 prevents the position detecting magnet 650, arranged in the recess of the bottom plate 640, from falling off.

A gap is left between the recess 642 of the bottom plate 640 and the loosely fitting member 502 (see FIG. 6). The inner peripheral surface of the recess 642 of the bottom plate 640 and the spherical surface of the base 504 of the loosely fitting member 502 are curved surfaces that face each other. This gap is narrow enough to allow, even when the bottom plate 640 comes into contact with the loosely fitting member 502, the first drive magnets 620 and the second drive magnets 621 to go back to their home positions due to their own magnetism. Thus, even if the camera device 3 has moved along the optical axis la while being located in the neutral position, the pair of first drive magnets 620 and the pair of second drive magnets 621 are still allowed to go back to their home positions.

As the movable unit 10 rotates, the position detecting magnet 650 changes its position, thus causing a variation in the magnetic force applied to the four magnetic sensors 92 provided for the printed circuit board 90. The four magnetic sensors 92 detect a variation, caused by the rotation of the position detecting magnet 650, in the magnetic force, and calculate two-dimensional angles of rotation with respect to the axes 1b and 1c. The four magnetic sensors 92 are arranged on the printed circuit board 90 so as to be parallel to a plane including the axes 1b and 1c. In this case, the four magnetic sensors 92 are arranged so as not to overlap with any of the pair of first drive magnets 620 or any of the pair of second drive magnets 621 when viewed along the optical axis la while the movable unit 10 is in the neutral position. This reduces the effect of the magnetic force of the pair of first drive magnets 620 and the magnetic force of the pair of second drive magnets 621, thus allowing the rotational position of the camera device 3 (movable unit 10) to be detected more accurately. In addition, the camera driver 1 further includes, separately from the four magnetic sensors 92, another magnetic sensor for detecting the rotation of the movable unit 10 (i.e., the rotation of the camera device 3) around the optical axis 1a. Note that the sensor for detecting the rotation around the optical axis la does not have to be a magnetic sensor but may also be a gyrosensor, for example.

In this case, the pair of first drive magnets 620 serves as attracting magnets, thus producing first magnetic attraction forces between the pair of first drive magnets 620 and the first magnetic yokes 710 that face the first drive magnets 620. Likewise, the pair of second drive magnets 621 also serves as attracting magnets, thus producing second magnetic attraction forces between the pair of second drive magnets 621 and the second magnetic yokes 711 that face the second drive magnets 621. The vector direction of each of the first magnetic attraction forces is parallel to a centerline that connects together the center of rotation 460, the center of mass of an associated one of the first magnetic yokes 710, and the center of mass of an associated one of the first drive magnets 620. The vector direction of each of the second magnetic attraction forces is parallel to a centerline that connects together the center of rotation 460, the center of mass of an associated one of the second magnetic yokes 711, and the center of mass of an associated one of the second drive magnets 621.

The first and second magnetic attraction forces become normal forces produced by the loosely fitting member 502 of the fixed unit 20 with respect to the spherical body 46. Also, when the movable unit 10 is in the neutral position, the magnetic attraction forces of the movable unit 10 define a synthetic vector along the optical axis la of the camera device 3 in the neutral position. This force balance between the first magnetic attraction forces, the second magnetic attraction forces, and the synthetic vector resembles the dynamic configuration of a balancing toy, and allows the movable unit 10 to rotate in three axis directions with good stability.

In this embodiment, the pair of first coil units 52, the pair of second coil units 53, the pair of first drive magnets 620, and the pair of second drive magnets 621 together form the driving unit 30.

The camera driver 1 of this embodiment allows the movable unit 10 to rotate two-dimensionally (i.e., pan and tilt) by supplying electricity to the pair of drive coils 720 and the pair of drive coils 721 simultaneously. In addition, the camera driver 1 also allows the movable unit 10 to rotate (i.e., to roll) around the optical axis la by supplying electricity to the pair of drive coils 730 and the pair of drive coils 731 simultaneously.

In this embodiment, those cables are grouped into two bundles of cables 11 (flexible flat cables) as described above (see FIG. 1B).

Each bundle of cables 11 includes a pulled-in portion 110, a proximate portion 111, and an extended portion 112.

The pulled-in portion 110 is extended from the first connector 121 (connection terminal) and is arranged to run from a point distant from the optical axis la when the camera device 3 is in the neutral position toward the center of rotation 460.

The proximate portion 111 is continuous with the pulled-in portion 110 so as to be located proximate to the center of rotation 460. The proximate portion 111 is held by the movable unit 10 so as to be clamped between the tip 441 of its associated holding portion 44 and the sidewall 431 of the body 43. More specifically, a first part 11a that forms part of the proximate portion 111 is held by the movable unit 10 so as to be clamped between the tip 441 of the holding portion 44 and the sidewall 431 of the body 43. A second part 11b, which is the rest of the proximate portion 111, is not clamped between the tip 441 of the holding portion 44 and the sidewall 431 of the body 43, and is deformable according to the rotational direction of the movable unit 10.

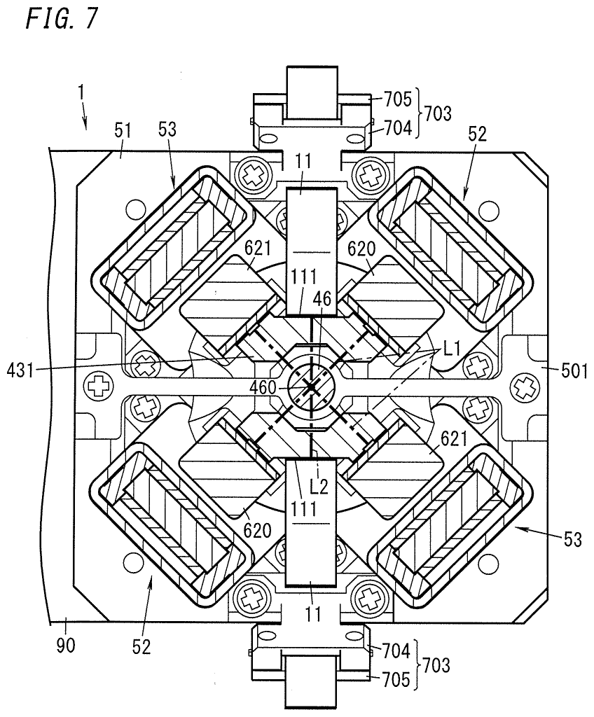

In the two bundles of cables 11 that face each other, the distance L2 between the two proximate portions 111 that face each other is shorter than the distance L1 between the two first drive magnets 620 (or the second drive magnets 621) that face each other (see FIG. 7). In other words, the proximate portions 111 are provided inside of a circle which is drawn around the center of rotation 460 and of which the diameter is defined by the distance L1 between the two first drive magnets 620 (or the second drive magnets 621).

Bringing the proximate portions 111 closer to the center of rotation 460 increases the distance from the proximate portions 111 to the fixing portions 703 as measured perpendicularly to the optical axis 1a when the camera device 3 is in the neutral position. This cuts down the loss of drive torque due to the tension of the bundles of cables 11, or the tension of the flexible portions 11c among other things, thus reducing the power consumption of the camera device 3 during its rotation.

In addition, the proximate portions 111 are partially included in a plane including a portion of the spherical body 46, of which the center is defined by the center of rotation 460, and intersecting at right angles with the optical axis la when the camera device 3 is in the neutral position (i.e., a plane intersecting with the optical axis la such that the optical axis 1a defines a normal to the plane).

Each extended portion 112 is continuous with (the second part 11b of) its associated proximate portion 111 so as to distance itself from the center of rotation 460. The extended portion 112, running from the associated proximate portion 111, is further extended outward from the movable unit 10 with respect to the center of rotation 460 to be partially fixed by an associated fixing portion 703. The second connector 122 described above is provided at the tip of the extended portion 112.

The second part 11b of the proximate portion 111 and a part of the extended portion 112 together form a flexible portion 11c. More exactly, part of the extended portion 112, running from a part thereof coupled to the proximate portion 111 through another part thereof fixed with the fixing portion 703, is included in the flexible portion 11c.

The fixing portions 703 are arranged to face each other perpendicularly to the direction in which the pair of protrusions 510 are disposed. Thus, the flexible portions 11c are extended outward perpendicularly to the coupling bar 501 from points that are arranged at equal intervals along the circumference of a circle drawn around the center of rotation 460 (see FIG. 1A). This allows the camera driver 1 to stabilize the orientation of the camera device 3 when the movable unit 10 is in the neutral position. In addition, this also allows the camera driver 1 to apply uniform tension from the respective bundles of cables 11 to the movable unit 10.

The flexible portions 11c are extended outward perpendicularly to the coupling bar 501. This configuration substantially levels the coupling bar 501 with the extension point along the optical axis la when the camera device 3 is in the neutral position. This reduces the height of the camera driver 1 (i.e., its axial length measured along the optical axis la when the camera device 3 is in the neutral position). In addition, arranging the pair of first drive magnets 620 (second drive magnets 621), the coupling bar 501, and the extension points of the bundles of cables 11 (or flexible portions 11c) at respectively different positions allows the distance L1 between the pair of first drive magnets 620 (or the pair of second drive magnets 621) to be shortened.

In each flexible portion 11c, the bundle of cables 11 is folded such that the extended portion 112, extended from the second part 11b of the associated proximate portion 111, distances itself from the center of rotation 460, and then the extended portion 112 has a plurality of folded parts. Specifically, after the bundle of cables 11 has been folded so as to distance itself from the center of rotation 460, the extended portion 112 is folded again toward the camera device 3 along the optical axis 1a, and then folded once again toward the associated fixing portion 703. That is to say, each flexible portion 11c has three folded parts, namely, a folded part A1 (coupling part) consisting of the second part 11b of the associated proximate portion 111 and the associated extended portion 112, and two more folded parts A2 and A3 formed by folding the extended portion 112. In this case, the bundles of cables 11 are routed such that the width of the bundles of cables 11(i.e., the direction in which the cables are arranged) becomes parallel to the axis 1c.

As described above, the bundles of cables 11 are routed such that the width of the bundles of cables 11(i.e., the direction in which the cables are arranged) becomes parallel to the axis 1c. Thus, when the movable unit 10 rotates in the tilting direction, reduced stress is produced with respect to the same magnitude of displacement of the bundles of cables 11. This allows the actuator 2 to rotate the movable unit 10 smoothly in the tilting direction.

Each flexible portion 11c has a plurality of folded parts, and therefore, has, at each folding point, a part generally parallel to the optical axis 1a when the camera device 3 is in the neutral position. Such a part generally parallel to the optical axis 1a is easily distorted as the camera device 3 rotates (particularly when the camera device 3 rotates in the rolling or panning direction). This allows the camera device 3 to expand the movable range of rotation.

In this embodiment, when measured along the optical axis la of the camera device 3 in the neutral position, the distance from the center of rotation 460 of the movable unit 10 to each extension point where an associated bundle of cables 11 is extended outward (hereinafter referred to as a “second distance”) is shorter than the distance from the center of rotation 460 to the first connector 121 (hereinafter referred to as a “first distance”). In this case, when measured along the optical axis la of the camera device 3 in the neutral position, the distance from the center of rotation 460 to the first connector 121 corresponds to the distance from the center of rotation 460 to the connection terminal at one end, designed to be electrically connected to the camera device 3, out of both ends of the bundle of cables 11. The extension point where the bundle of cables 11 is extended outward corresponds to a point of connection where the associated proximate portion 111 and extended portion 112 are connected together. The extension point also corresponds to the part where the proximate portion 111 and the extended portion 112 are coupled together, i.e., the folded part A1. That is to say, the first distance is the distance from the center of rotation 460 to a projection point where the center of the connection terminal is projected perpendicularly to the optical axis 1a. The second distance is the distance from the center of rotation 460 to a projection point where the center of the folded part A1 is projected perpendicularly to the optical axis 1a.

Shortening the distance from the center of rotation 460 to the extension point along the optical axis 1 a when the camera device 3 is in the neutral position reduces the degree of torsional displacement of the bundles of cables 11 when the camera device 3 is rotated. That is to say, this allows the camera driver 1 to rotate the camera device 3 with less force (particularly in the rolling and panning directions).

### Variations

Next, variations will be enumerated one after another. Note that any of the variations to be described below may be combined as appropriate with the embodiment described above.

In the embodiment described above, each bundle of cables 11 is configured as flexible flat cables. However, this configuration is only an example and should not be construed as limiting. Alternatively, the bundle of cables 11 may also be a bundle of fine-line coaxial cables that are arranged in a predetermined direction. Still alternatively, the bundle of cables 11 may also be a bundle of coated cables that are arranged in a predetermined direction. That is to say, the bundle of cables 11 only needs to have an anisotropic flexural property.

Also, in the embodiment described above, the spherical body 46 is configured to be fitted and fixed into the through hole 451 of the loosely fitting member 45. However, this configuration is only an example and should not be construed as limiting. Alternatively, the spherical body 46 may also be configured to be fixed into the recess 506 of the loosely fitting member 502. In that case, an inner peripheral surface of the through hole 451 of the loosely fitting member 45 corresponds to the first loosely fitting face and the raised spherical surface of the spherical body 46 protruding from the loosely fitting member 502 corresponds to the second loosely fitting face. The raised spherical surface (second loosely fitting face) of the spherical body 46 protruding from the loosely fitting member 502 makes a point or line contact with the inner peripheral surface (first loosely fitting face) of the through hole 451 of the loosely fitting member 45 so as to be loosely fitted into the first loosely fitting face with a narrow gap left between them.

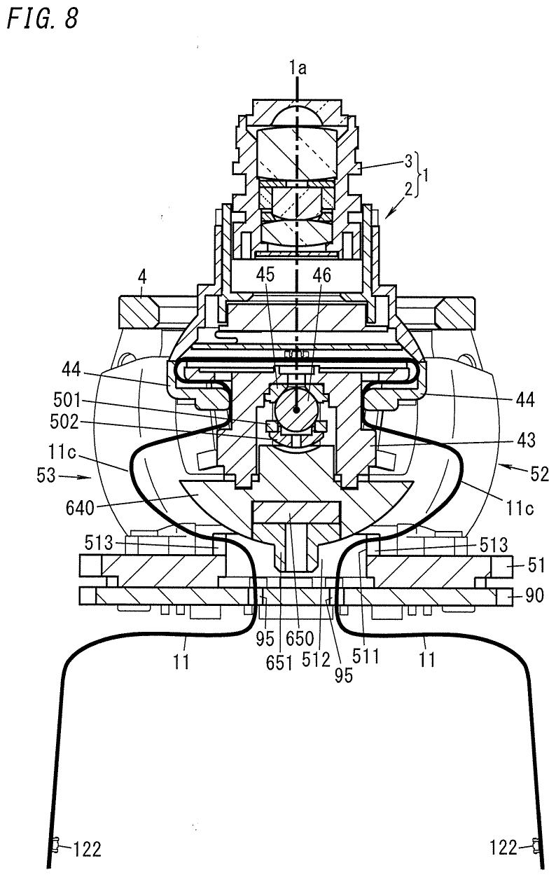

Furthermore, in the embodiment described above, the flexible portions 11c are configured to be extended outward perpendicularly to the coupling bar 501 so as to be arranged at equal intervals along the circumference of a circle drawn around the center of rotation 460. However, this configuration is only an example and should not be construed as limiting. Alternatively, the flexible portions 11c may also be arranged without being extended outward, i.e., so as not to be extended out of the external surfaces of any of the first coil units 52 or the second coil units 53 (see FIG. 8). In that case, the bundles of cables 11 need to be passed through a through hole 512 cut through a central region of the body 51 of the fixed unit 20. For that purpose, a plurality of first through holes 513 corresponding in number to the bundles of cables 11 are cut through a wall 511 surrounding the through hole 512 so as to run perpendicularly to the optical axis 1a when the camera device 3 is in the neutral position. In the example shown in FIG. 8, a pair of first through holes 513 is provided. In addition, the printed circuit board 90 is also provided with a plurality of second through holes 95 corresponding in number to the bundles of cables 11. In the example illustrated in FIG. 8, a pair of second through holes 95 is provided. Each bundle of cables 11 is routed through its associated first and second through holes 513 and 95. Optionally, if the plurality of magnetic sensor 92 and the position detecting magnet 650 interfere with routing, then the plurality of magnetic sensor 92 and the position detecting magnet 650 may be relocated or may even be removed.

Furthermore, in the embodiment described above, each bundle of cables 11 is configured to be routed such that the width of the bundle of cables 11 is parallel to the axis 1c. However, this configuration is only an example and should not be construed as limiting. Alternatively, each bundle of cables 11 may also be routed such that the width of the bundle of cables 11 is parallel to the axis 1b. That is to say, the bundle of cables 11 may be routed such that the width of the bundle of cables 11 becomes parallel to one of the three rotational directions except the rolling direction (namely, either the axis 1b or the axis 1c in this embodiment).

In the various embodiments described above, the actuator 2 is configured to be combined with the camera device 3. However, this configuration is only an example and should not be construed as limiting. The actuator 2 may also be configured to be combined with a laser pointer, a projector, or any other optical system device having a virtual axis (optical axis).

### Resume

As can be seen from the foregoing description, an actuator (2) according to a first aspect includes a movable unit (10), a fixed unit (20), and at least two bundles of cables (11). The movable unit (10) holds an optical system device (such as a camera device 3) thereon. The fixed unit (20) supports the movable unit so as to make the movable unit (10) rotatable. The at least two bundles of cables (11) each have an anisotropic flexural property. Each of the at least two bundles of cables (11) includes a flexible portion (11c) between a first end (first connector 121) thereof electrically connected to the optical system device and a second end (second connector 122) thereof electrically connected to an external circuit. Respective flexible portions (11c) of the at least two bundles of cables (11) are arranged at equal intervals along a circumference of a circle drawn around a center of rotation (460) of the movable unit (10) in a neutral position. Each of the at least two bundles of cables (11) has an extension point. The bundle of cables (11) is extended from the movable unit (10) at the extension point so as to distance itself from the center of rotation (460). When measured along an optical axis (1a) of the optical system device, distance from the center of rotation (460) to the extension point is shorter than distance from the center of rotation (460) to a connection terminal at the first end.

This configuration allows the actuator (2) to reduce the degree of torsional displacement of the bundles of cables (11) when the optical system device is rotated. That is to say, this configuration allows the actuator (2) to rotate the optical system device with less force.

In an actuator (2) according to a second aspect, which may be implemented in conjunction with the first aspect, the bundle of cables (11) includes a pulled-in portion (110), a proximate portion (111), and an extended portion (112). The pulled-in portion (110) is continuous with the connection terminal and routed so as to run from a point distant from the optical axis (1a) toward the center of rotation (460). The proximate portion (111) is continuous with the pulled-in portion (110) so as to be located proximate to the center of rotation (460) and held by the movable unit (10). The extended portion (112) is continuous with the proximate portion (111) so as to distance itself from the center of rotation (460) and included in the flexible portion (11c). A coupling point where the proximate portion (111) and the extended portion (112) are coupled together defines the extension point.

This configuration allows the actuator (2) to extend each bundle of cables (11) outward from a point proximate to the center of rotation (460), thus reducing the degree of torsional displacement of the bundles of cables (11) when the optical system device is rotated.

In an actuator (2) according to a third aspect, which may be implemented in conjunction with the second aspect, the proximate portion (111) includes: a first part (11a) fixed to the movable unit (10); and a second part (11b) configured to be deformable as the movable unit (10) rotates and included in the flexible portion (11c).

According to this configuration, as the camera device (3) rotates, the second part (11b) is easily distorted. This allows the actuator (2) to expand the movable range of rotation of the camera device (3).

In an actuator (2) according to a fourth aspect, which may be implemented in conjunction with the second or third aspect, the coupling point is provided by folding the bundle of cables (11) such that the extended portion (112) distances itself from the center of rotation (460), and the extended portion (112) has a plurality of folded parts.

According to this configuration, the flexible portion (11c) has a plurality of folded parts, which are easily distorted as the camera device (3) rotates. This allows the actuator (2) to expand the movable range of rotation of the camera device (3).

An actuator (2) according to a fifth aspect, which may be implemented in conjunction with any one of the second to fourth aspects, further includes a plurality of drive magnets (including a pair of first drive magnets 620 and a pair of second drive magnets 621) and a plurality of drive coil units (including a pair of first coil units 52 and a pair of second coil units 53). The plurality of drive magnets are provided for the movable unit (10) so as to face each other with respect to the optical axis (1a). The plurality of drive coil units are provided for the fixed unit (20) so as to respectively face the plurality of drive magnets. The movable unit (10) is electromagnetically driven in rotation with respect to the fixed unit (20) by the plurality of drive magnets and the plurality of drive coil units. The proximate portion (111) is provided inside of a circle which is drawn around the center of rotation (460) and of which the diameter is defined by a distance (L1) between two facing ones of the drive magnets.

This configuration allows the actuator (2) to cut down the loss of drive torque due to the tension of the bundles of cables (11), or the tension of the flexible portions (11c) among other things, by bringing the proximate portion (111) closer to the center of rotation (460). This allows the actuator (2) to reduce the power consumption of the optical system device (camera device 3) during its rotation.

In an actuator (2) according to a sixth aspect, which may be implemented in conjunction with any one of the first to fifth aspects, the movable unit (10) has a first loosely fitting face (461). The fixed unit (20) includes a coupling member (50) and a body (51) to support the coupling member (50). The coupling member (50) has a second loosely fitting face (507) to be fitted loosely onto the first loosely fitting face (461) via point or line contact and supports the movable unit (10) rotatably. One of the first and second loosely fitting faces (461, 507) defines an inner peripheral surface of a recess and the other of the first and second loosely fitting faces (461, 507) defines at least one raised spherical surface.

This configuration allows the fixed unit (20) to pivotally support the movable unit (10). This allows the actuator (2) to make the movable unit (10) rotatable with respect to the fixed unit (20).

In an actuator (2) according to a seventh aspect, which may be implemented in conjunction with the sixth aspect, the coupling member (50) includes a linear coupling bar (501). Both ends of the coupling bar (501) are secured onto the body (51).

This configuration requires a smaller arrangement space compared with a situation where crossed coupling bars are used, thus cutting down the size of the actuator (2).

In an actuator (2) according to an eighth aspect, which may be implemented in conjunction with the seventh aspect, the flexible portion (11c) of the bundle of cables (11) is extended from the extension point perpendicularly to the coupling bar (501).

This configuration substantially levels the coupling bar (501) with the extension point along the optical axis (1a) when the camera device (3) is in a neutral position. This reduces the height of the actuator (2) (i.e., its axial length measured along the optical axis 1a when the camera device 3 is in the neutral position).

A camera driver (1) according to a ninth aspect includes the actuator (2) according to any one of the first to eighth aspects, and a camera device (3) serving as the optical system device.

This configuration allows the camera driver (1) to reduce the degree of torsional displacement of the bundles of cables (11) when the camera device (3) is rotated. That is to say, this configuration allows the actuator (2) to rotate the camera device (3) with less force.

1. An actuator comprising:
a movable unit configured to hold an optical system device thereon;
a fixed unit configured to support the movable unit so as to make the movable unit rotatable; and
at least two bundles of cables, each having an anisotropic flexural property,
each of the at least two bundles of cables including a flexible portion between a first end thereof electrically connected to the optical system device and a second end thereof electrically connected to an external circuit,
respective flexible portions of the at least two bundles of cables being arranged at equal intervals along a circumference of a circle drawn around a center of rotation of the movable unit in a neutral position,
each of the at least two bundles of cables having an extension point,
the bundle of cables being extended from the movable unit at the extension point so as to distance itself from the center of rotation,
when measured along an optical axis of the optical system device, distance from the center of rotation to the extension point being shorter than distance from the center of rotation to a connection terminal at the first end.

2. The actuator of claim 1, wherein
the bundle of cables includes:
a pulled-in portion continuous with the connection terminal and routed so as to run from a point distant from the optical axis toward the center of rotation;
a proximate portion continuous with the pulled-in portion so as to be located proximate to the center of rotation and held by the movable unit; and
an extended portion continuous with the proximate portion so as to distance itself from the center of rotation and included in the flexible portion, wherein
a coupling point where the proximate portion and the extended portion are coupled together defines the extension point.

3. The actuator of claim 2, wherein
the proximate portion includes: a first part fixed to the movable unit; and a second part configured to be deformable as the movable unit rotates and included in the flexible portion.

4. The actuator of claim 2, wherein
the coupling point is provided by folding the bundle of cables such that the extended portion distances itself from the center of rotation, and
the extended portion has a plurality of folded parts.

5. The actuator of claim 2, further comprising:
a plurality of drive magnets provided for the movable unit so as to face each other with respect to the optical axis; and
a plurality of drive coil units provided for the fixed unit so as to respectively face the plurality of drive magnets, wherein
the movable unit is electromagnetically driven in rotation with respect to the fixed unit by the plurality of drive magnets and the plurality of drive coil units, and
the proximate portion is provided inside of a circle which is drawn around the center of rotation and of which the diameter is defined by a distance between two facing ones of the drive magnets.

6. The actuator of claim 1, wherein
the movable unit has a first loosely fitting face,
the fixed unit includes: a coupling member having a second loosely fitting face configured to be fitted loosely onto the first loosely fitting face via point or line contact and to support the movable unit rotatably; and a body configured to support the coupling member, and
one of the first and second loosely fitting faces defines an inner peripheral surface of a recess and the other of the first and second loosely fitting faces defines at least one raised spherical surface.

7. The actuator of claim 6, wherein
the coupling member includes a linear coupling bar,
both ends of the coupling bar being fixed onto the body.

8. The actuator of claim 7, wherein
the flexible portion of the bundle of cables is extended from the extension point perpendicularly to the coupling bar.

9. A camera driver comprising:
the actuator of claim 1, and
a camera device serving as the optical system device.
